(19) United States
(12) Patent Application Publication
(10) Pub. No.: US 2022/0002136 A1
(43) Pub. Date: Jan. 6, 2022

(54) SELF VENTING VALVE CLOSURE

(71) Applicants: Robert TANSLEY, Bidford on Avon, Warwickshire (GB); Philip Andrew WALTON, Bishop Auckland Durham (GB); Sergio SONZOGNI, Bergamo (IT)

(72) Inventors: Robert TANSLEY, Bidford on Avon, Warwickshire (GB); Philip Andrew WALTON, Bishop Auckland Durham (GB); Sergio SONZOGNI, Bergamo (IT)

(21) Appl. No.: 17/289,917

(22) PCT Filed: Nov. 8, 2019
(86) PCT No.: PCT/GB2019/053158

§ 371 Date: Apr. 29, 2021

(30) Foreign Application Priority Data
Nov. 9, 2018 (GB) 1818330.1

(51) Int. Cl. B67D 1/08

(52) U.S. Cl. CPC B67D 1/0835; B67D 1/0849

(57) ABSTRACT

A valve closure for a keg, e.g. incorporating an A-type valve arrangement, has a gas inlet port 11, a liquid dispensing port 12 and a valve member 6 to sealably close the gas inlet and liquid dispensing ports. A venting mechanism includes a detent 23 which can be activated by rotating the valve member 6 after the keg has been filled. This mechanism, when activated, primes a resiliently deflectable circumferential arm 22 to move the detent between the sealing face of the valve member 6 and its valve seat when the valve is next connected for dispensing. When the mechanism is not activated it does not interfere with the normal opening and closing of the valve, e.g. during filling

### TECHNICAL FIELD OF THE INVENTION

This invention relates to closures which incorporate valves. Such closures are used with liquid containers such as beer kegs and are configured to enable the liquid contents to be dispensed by gas pressure.

### BACKGROUND

Kegs containing carbonated beverages are, due to the nature of carbonated beverages, under internal pressure. This pressure is dependent on the level of carbonation (amount of dissolved CO₂) and the temperature of the beverage. To dispense the contents of a keg, a gas is introduced into the keg under pressure in order to displace the contents. Such kegs normally have a closure incorporating a twin valve arrangement which facilitates the simultaneous introduction of the dispense gas and extraction of the beverage. These valves also provide access for filling the keg with beverage and they normally open and close both paths upon connection and disconnection. It is vital that these valves are fully closed after the beverage has been introduced so as not to lose carbonation.

The pressure of gas used to dispense must be greater than the equilibrium pressure of the dissolved CO₂ so that the level of carbonation is maintained throughout the dispense process. Dispensing is usually considered complete after all of the beverage has been extracted. However, for various reasons a keg may sometimes be left with some residual beverage, when the shelf life of the product has expired for example.

After dispensing, the dispense gas remains inside the keg under the same pressure as used for the dispense. This is undesirable as a keg under pressure may pose a threat to safety during a later recycling or disposal process. It is therefore desirable that this pressure is released after dispensing is complete. Various systems already exist which allow an operator to manually release this pressure with or without the use of tools. However, this relies totally on the operator carrying out this safety procedure at the appropriate time.

Valve closures exist which automatically latch the valve in an open position when the valve is operated during dispense, but the closures incorporate extra moving parts which increase the size and complexity of the closure.

A common form of valve closure is known as an A-type valve, which is also similar to a G-type valve. Both have a fixed central core pin and a single spring-loaded valve member which controls two ports. When engaged with a suitable valve-operating member, gas can be fed into the container past the outer periphery of the valve element while beer simultaneously flows out of the container past the inner periphery of the element. Other forms of valve closure are also used with beer kegs. Operationally, S, D and M types are similar to each other in that they all have no fixed central core pin but have two concentric spring-loaded moving valve members which separately control the two ports. Generally the valve members are operated by respective spring elements, but the valve members may be cascaded such that closure of one spring-loaded valve member causes closure of the other.

### SUMMARY OF THE INVENTION

When viewed from one aspect the present invention proposes a valve closure:
a closure body (1) for attachment to a container,
a gas inlet port (11),
a liquid dispensing port (12),
valve means to sealably close the gas inlet and liquid dispensing ports, said valve means including an axially movable valve member (6) having a sealing face (28) which is co-operable with a valve seat (9) formed by an annular wall (2) to sealably close the gas inlet port;
a detent (23) movable into a venting position in which the detent prevents the valve means (6) from sealably closing the gas inlet port;
   characterised in that, in said venting position, the detent (23) is interposed between the sealing face (28) and the valve seat (9).

The invention also provides a valve closure having a detent (23) which is carried by an arm (22) which extends circumferentially about a valve member (6).

The invention also provides a valve closure having a valve member (6) which is rotatable to move a retainer (34) which is operable to hold a detent (23) in an inoperative position.

The invention also provides a valve closure having a detent (23) carried by a resiliently deflectable arm (22) which extends circumferentially about a rotatable valve member (6), and a retainer (34) carried by the valve member holds the detent (23) in the inoperative position by engagement with the resiliently deflectable arm.

The invention also provides a valve closure in combination with a rotating tool to engage and rotate a valve member (6).

### BRIEF DESCRIPTION OF THE DRAWINGS

The following description and the accompanying drawings referred to therein are included by way of non-limiting example in order to illustrate how the invention may be put into practice. In the drawings:

FIG. 1 is an axial section through an A-type valve closure in a closed configuration;

FIG. 2 is a similar axial section through the A-type valve closure in the dispensing configuration;

FIG. 3 is a general view of the body of the valve closure as seen from the underside;

FIG. 4 is a general view of a venting member of the valve closure;

FIG. 5 is a general view of the valve member of the valve closure as seen from the top;

FIG. 6 is a general view of the valve closure showing the valve member being rotated by a castellated tool;

FIG. 7 is a transverse section through the valve closure, seen from above, showing the venting member held in an inoperative condition;

FIG. 8 is a transverse section through the valve closure showing the venting member in an operative condition;

FIG. 9 is an axial section through part of the valve closure showing the venting member in an operative condition prior to opening of the valve;

FIG. 10 is an axial section through part of the valve closure showing the venting member in an operative condition with the valve open;

FIG. 11 is an axial section through part of the valve closure showing the venting member in an operative condition after the valve has re-closed;

FIG. 12 is a general view of the valve closure showing the valve member being rotated by a modified operating tool.

### DETAILED DESCRIPTION OF THE DRAWINGS

For the purpose of example the valve closure shown in the drawings is of the kind known as an A-type valve. All components of the valve closure may be moulded of polymeric materials (plastics) so that the closure is fully recyclable. A preferred form of valve closure is described in EP 2 585 400 A1.

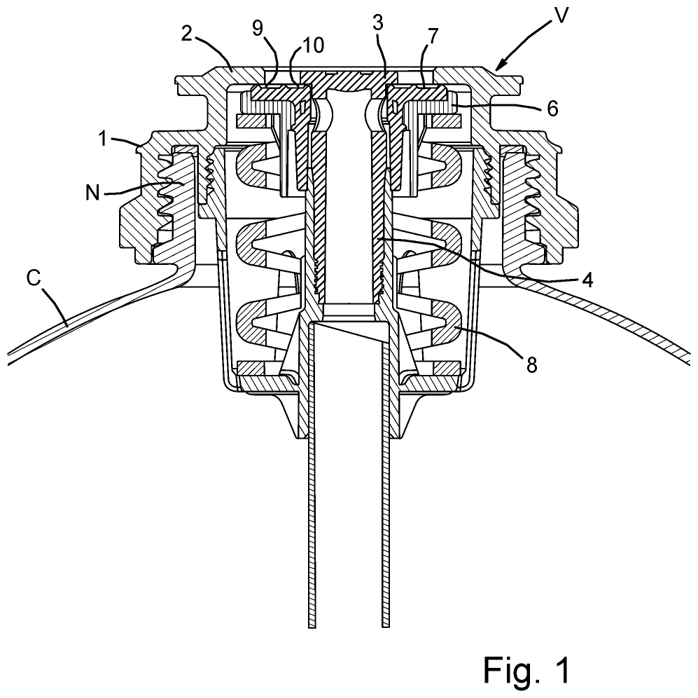

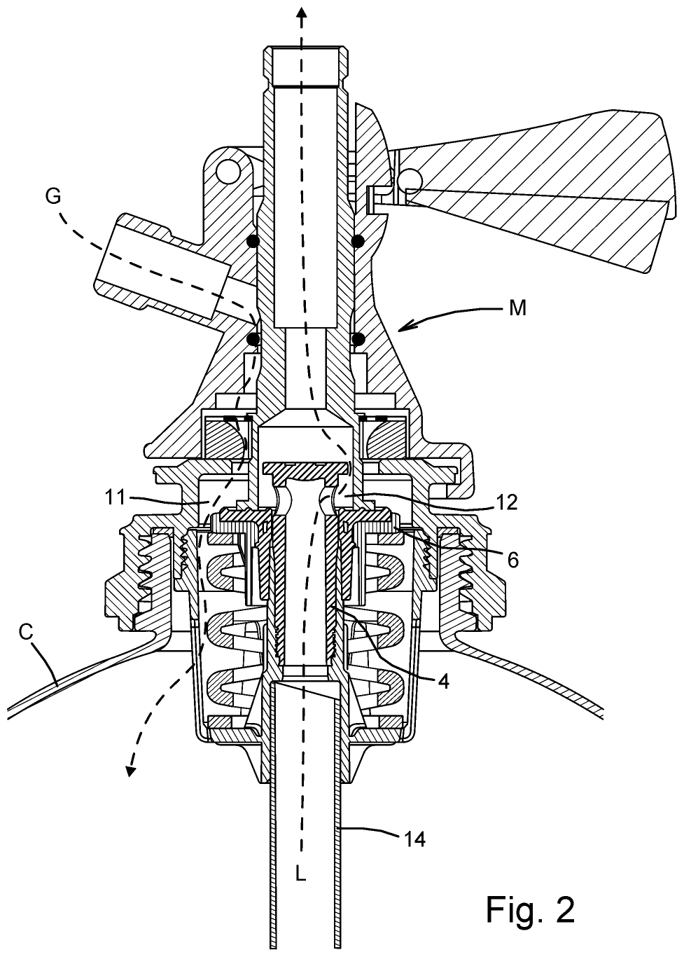

Referring firstly to FIG. 1, the valve closure V comprises a closure body 1 which is adapted to be fitted onto the neck N of a beverage container C such as a beer keg, which is typically formed by stretch blow moulding. The closure body has an annular top wall 2 which is concentric with a fixed disc-shaped cap 3 formed at the upper end of a hollow core pin 4. A valve member 6 includes a resilient seal 7 and is spring-loaded by a compression spring 8 which sealingly urges the valve member against an outer valve seat 9 formed around the inner periphery of the annular top wall 2 and an inner valve seat 10 formed around the periphery of the cap 3. To dispense a liquid product from the container the valve member 6 is engaged by a cylindrical valve-operating member M as in FIG. 2. The valve member 6 is depressed against its spring-loading and makes sealing contact with the valve-operating member M to provide separate gas and liquid flow paths past the valve-operating member, indicated by the broken arrows G and L respectively. Pressurised gas is fed into the container C through a gas inlet port 11. Liquid simultaneously flows out of the container through a draw tube 14 and the core pin 4, exiting through a liquid dispensing port 12.

Normally, when dispensing is finished and the valve-operating member M is disconnected, the valve member 6 returns to the sealing condition shown in FIG. 1, holding the internal gas pressure within the container together with any residual liquid. However, the present valve closure incorporates a self-venting mechanism for automatically venting any residual dispensing gas after use so that the keg is no longer under pressure whilst maintaining a fully sealed state after initial keg manufacture and filling.

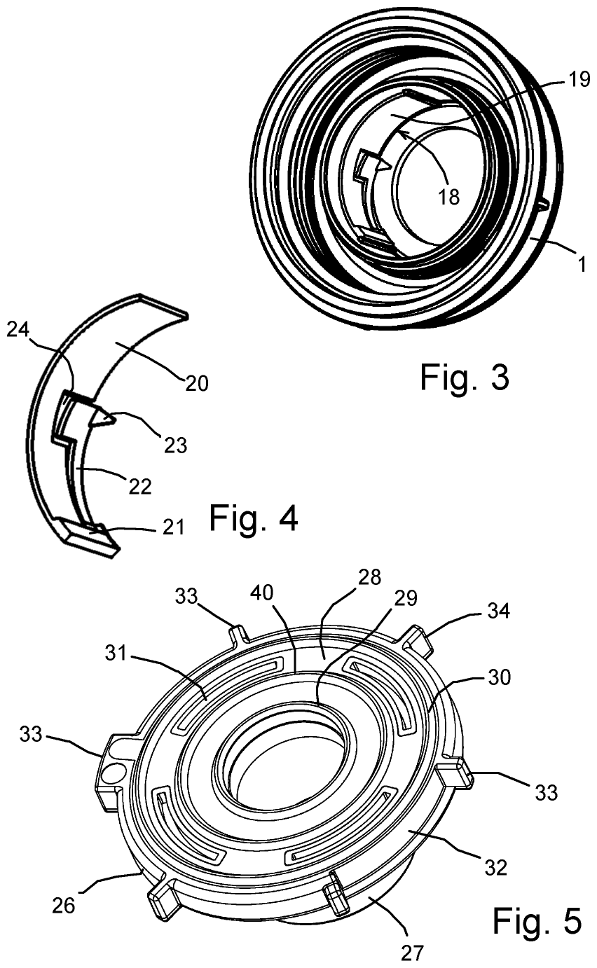

Referring to FIG. 3, the closure body 1 contains a shallow part-circumferential internal recess 18 which contains a venting member 19. The venting member is disposed opposite the outer periphery of the valve member 6, which has been omitted from the drawing for clarity. The venting member 19, shown separately in FIG. 4, may be integrally moulded to include a curved wall 20 with a stop 21 at one end. Adjacent to the stop 21 a curved resiliently deflectable spring arm 22 extends inwardly towards the valve member 6, carrying an inwardly-projecting tongue which forms a detent 23 at the free end of the spring arm. The curved wall 20 contains a recess 24 which allows the spring arm 22 to be depressed in an outward direction without being impeded by the wall 20.

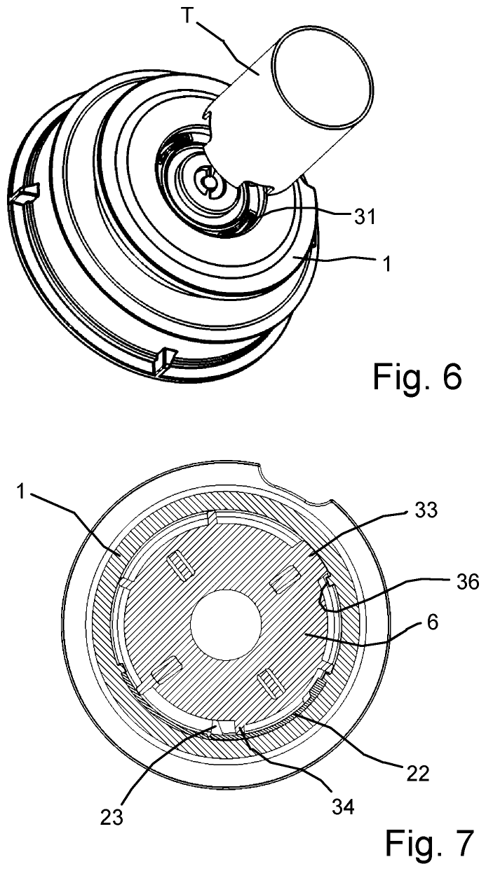

The valve member 6 is rotatably mounted within the closure body. As seen in FIG. 5, the valve member has an annular sealing wall 26 which is integrally formed with an axially-extending cylindrical portion 27. The sealing wall 26 has a sealing face 28, remote from the cylindrical portion 27, which includes an inner sealing bead 29 for sealing contact with the cap 3, an intermediate sealing bead 40 for sealing contact with the valve operating member M (FIG. 2), and an outer sealing bead 30 for sealing contact with the annular wall 2. Between two of the sealing beads, 30 and 40, the top face 28 contains slots 31 which may be engaged by a suitable tool in order to rotate the valve member, such as the castellated tool T (e.g. a filling head) shown in FIG. 6. Projecting ribs or other suitable engagement means could alternatively be provided by which the valve member may be engaged for rotation. Referring back to FIG. 5, the outer periphery of the sealing wall 26 has an axially extending side face 32 which carries a number of radial projections 33. The radial projections 33 generally guide the valve member for smooth axial movement under the action of the spring 8. One of the radial projections 34 acts as an axially-extending retainer 34. As shown in the sectional view of FIG. 7, the valve member 6 can be rotated to an inoperative position (clockwise as shown) which is determined by engagement of one or more of the projections 33 with stop projections 36 on the interior of the closure body 1. When The retainer 34 is located opposite the free end of the spring arm 22 as shown, the retainer depresses the spring arm radially outwards into the recess 24 holding the venting member 19 inoperative. The valve member 6 is free to slide axially within the closure body, e.g. when the valve is opened during filling, but the axial extent of the retainer 34 is sufficient to hold the spring arm 22 within the recess 24. When the valve re-closes, e.g. on disconnection of the filling head, the detent 23 does not impede closure of the valve member 6, which can return to the sealing position, fully closing both of the flow paths G and L. The valve closure can thus be opened and re-closed as required as long as the valve member remains in this rotational position.

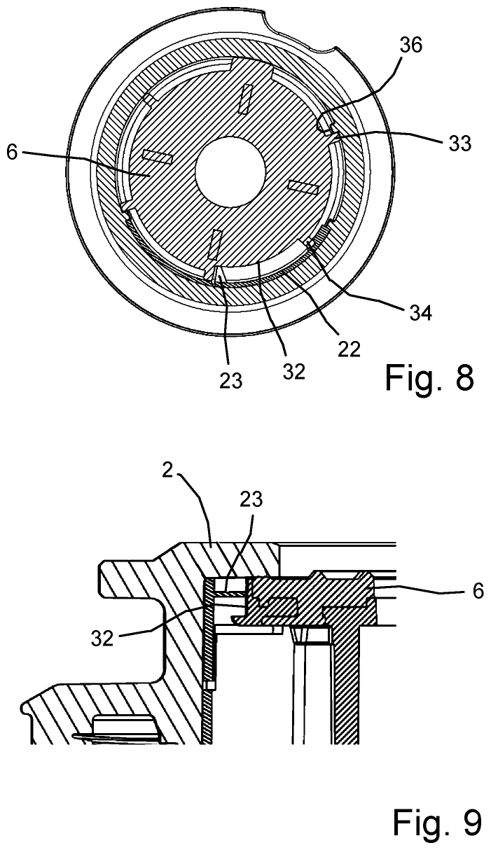

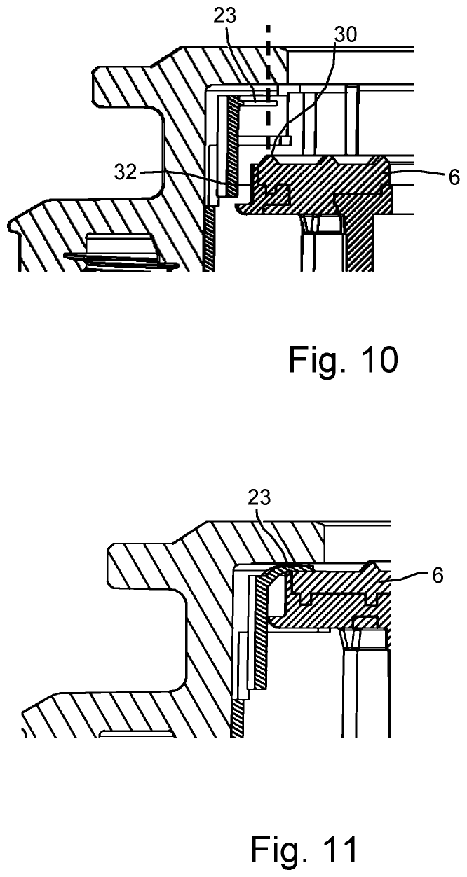

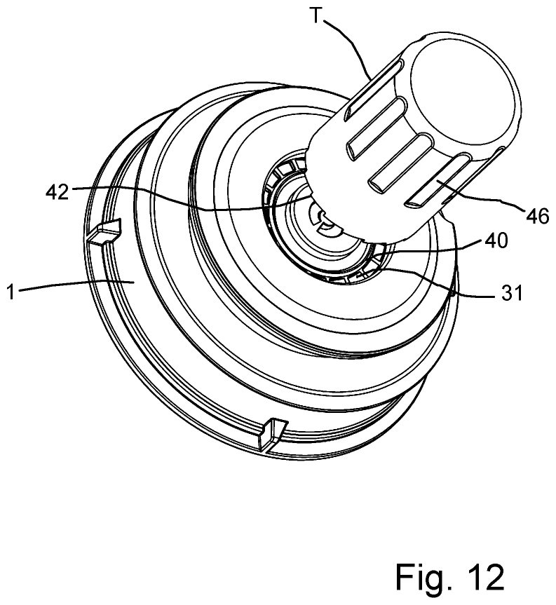

FIG. 8 shows the valve member 6 rotated into an operative condition, which may, for example, be carried out by the filling head after closure of the valve or by a separate tool following disconnection of the filling head and before delivery to the end user. In this condition the rotational position of the valve member 6 (anti-clockwise as shown) is again determined by engagement of projections 33 with stop projections 36 on the interior of the closure body 1. However, the retainer 34 is now located at the root of the spring arm 22 allowing the spring arm to move radially inwards until the detent 23 contacts the side face 32 of the valve member, as shown in FIG. 9. The valve member 6 is again free to slide axially within the closure body when the valve is opened to dispense the product, but once the valve is fully opened the detent 23 is permitted to move between the sealing face of the valve member and the annular top wall 2, overlying the outer bead 30 as shown in FIG. 10. Now, when the valve re-closes, e.g. on disconnection of the dispense head, the detent 23 interferes with the sealing action of the outer sealing bead 30, seen in FIG. 11, allowing the dispensing gas to slowly vent from the container. It will be noted that the tongue-like detent 23 is able to distort, thereby limiting it's effect on final resting position of the valve member 6.

The size and shape of the detent 23 determines the amount of seal interference thus regulating the rate of pressure loss when the valve is closed. It is generally desirable that the rate of pressure loss is relatively slow, typically taking several minutes to fully vent the dispensing gas. Activation of the venting member would not therefore prevent a keg being moved between dispensing positions within a short period, for example.

A modified tool for manually rotating the valve member 6 within the closure body 1 is shown in FIG. 12. The top face of the valve member again contains a ring of circumferential slots 31 between the outer sealing bead and the exposed intermediate sealing bead 40, but in this case the slots are closely spaced to allow rapid engagement. The tool T is generally cylindrical with indentations 46 for manually gripping and rotating the tool. The opposite end of the tool has a ring of circumferentially-arranged teeth 42, with axially-extending leading edges and inclined trailing edges, which enables the teeth to drivably engage within the the slots 31.

In summary, the valve closure described herein maintains an effective seal after filling but automatically vents the dispensing gas after dispense is complete. The venting mechanism can be activated after the keg has been filled and with the valve closed. This mechanism, when activated, primes a spring loaded arm that interferes with the normal sealing of the dispensing gas port when the valve is next operated, i.e. connected for dispensing. When the mechanism is not activated it does not interfere with the normal sealing function and opening and closing of the valve can be carried out as normal. The party filling the keg can choose whether or not to activate the automatic venting function after filling.

The venting mechanism can be applied to the dispensing gas valve in all the common valve formats A, G, S, D and M types.

Whilst the above description places emphasis on the areas which are believed to be new and addresses specific problems which have been identified, it is intended that the features disclosed herein may be used in any combination which is capable of providing a new and useful advance in the art.

1. A valve closure:
a closure body (1) for attachment to a container,
a gas inlet port (11),
a liquid dispensing port (12),
valve means to sealably close the gas inlet and liquid dispensing ports, said valve means including an axially movable valve member (6) having a sealing face (28) which is co-operable with a valve seat (9) formed by an annular wall (2) to sealably close the gas inlet port;
a detent (23) movable into a venting position in which the detent prevents the valve means (6) from sealably closing the gas inlet port;
characterised in that, in said venting position, the detent (23) is interposed between the sealing face (28) and the valve seat (9).

2. A valve closure according to claim 1 wherein the detent (23) is carried by an arm (22) which extends circumferentially about said valve member (6).

3. A valve closure according to claim 2 wherein the arm (22) is resiliently deflectable to move the detent (23) towards the venting position.

4. A valve closure according to claim 1 wherein the valve member (6) comprises a side face (32) provided with a retainer (34) which is operable to hold the detent (23) in an inoperative position during opening and closing of the gas inlet port (11).

5. A valve closure according to claim 4 wherein the valve member (6) is rotatable to move the retainer (34) out of the inoperative position.

6. A valve closure according to 5 wherein the detent (23) is carried by a resiliently deflectable arm (22) which extends circumferentially about said valve member (6), and the retainer (34) holds the detent (23) in the inoperative position by engagement with the resiliently deflectable arm.

7. A valve closure according to claim 5 wherein the sealing face (28) of the valve member contains circumferential slots (31) for engagement by a rotating tool.

8. A valve closure according to claim 5 in combination with a rotating tool provided with means to engage and rotate the valve member (6).

9. A container provided with a valve closure according to claim 1.
